(19) United States
(12) Patent Application Publication
(10) Pub. No.: US 2025/0238906 A1
(43) Pub. Date: Jul. 24, 2025

(54) SYSTEM AND METHOD FOR RESTORATION OF AN IMAGE

(71) Applicant: SAMSUNG ELECTRONICS CO., LTD., Suwon-si (KR)

(72) Inventors: Amit Satish UNDE, Karnataka (IN); Siddharth Deepak ROHEDA, Karnataka (IN); Sameer Suhail MOHAMMAD, Karnataka (IN); Shreyas PANDITH, Karnataka (IN); Rahul MISHRA, Karnataka (IN); Minkyu LEE, Suwon-si (KR); Heetak CHUNG, Suwon-si (KR); Woojhon CHOI, Suwon-si (KR)

(73) Assignee: SAMSUNG ELECTRONICS CO., LTD., Suwon-si (KR)

(21) Appl. No.: 19/174,629

(22) Filed: Apr. 9, 2025

Related U.S. Application Data
(63) Continuation of application No. PCT/IB2024/062252, filed on Dec. 5, 2024.

(30) Foreign Application Priority Data
Dec. 5, 2023 (IN) 202341082915
Nov. 29, 2024 (IN) 202341082915

(51) Int. Cl. G06T 5/70; G06T 3/40

(52) U.S. Cl. CPC G06T 5/70; G06T 3/40; G06T 2207/10024; G06T 2207/20021

(57) ABSTRACT

A method for restoration of a captured image includes: blurring the captured image based on removing high spatial frequency content and maintaining colour characteristics of the captured image; generating a global colour attention map corresponding to the blurred captured image, where the global colour attention map indicates spatial representation of colour composition among regions within the blurred captured image; splitting the captured image into a plurality of patches; extracting one or more task features from the plurality of patches, where the one or more task features indicate characteristics related to a corresponding task; and generating stitched features corresponding to the plurality of patches, respectively, based on correlating the one or more task features and the global colour attention map, where the stitched features indicate an integrated representation of the captured image based on a global context and the corresponding task.

### CROSS-REFERENCE TO RELATED APPLICATION(S)

This application is a continuation application, claiming priority under §365(c), of an International application No. PCT/IB2024/062252, filed on Dec. 5, 2024, which is based on and claims the benefit of a Indian patent application number 202341082915, filed on Dec. 5, 2023, and a Indian patent application number 202341082915, filed on Nov. 29, 2024 in the Indian Intellectual Property Office, the disclosure of which is incorporated by reference herein in its entirety.

### BACKGROUND

### 1. Field

The present disclosure relates to image processing, and more particularly relates to a system and a method for restoration of colour consistent restoration of an image.

### 2. Description of Related Art

The rapid advancement of mobile camera sensors has revolutionized the field of image and photo enhancement, paving the way for sophisticated applications. These applications have made it possible for even the most casual smartphone users to capture images with clarity and precision that rival those taken with professional equipment. However, despite these technological strides, persistent issues continue to degrade the perceptual quality of images for instance, moiré patterns and uneven illumination.

Moiré patterns occur when the fine details of an image interfere with the pixel grid of the camera sensor, leading to unwanted wave-like artifacts. Uneven illumination, on the other hand, refers to inconsistent lighting across different areas of an image, which can cause some regions to appear too dark or too bright. These problems may be particularly challenging because they are often subtle and can be difficult to eliminate without affecting other aspects of the image. As a result, there remain significant obstacles in the quest for perfect image quality.

Artificial intelligence (AI) has emerged as a powerful tool for addressing these and other issues in image restoration. AI-based techniques can intelligently analyse and correct imperfections in images, often with remarkable accuracy. However, even AI based techniques may have certain drawbacks. The computational demands of AI-based image restoration are substantial, making it difficult to implement these methods on resource-constrained mobile devices, particularly when dealing with high-resolution images greater than 8 megapixels (MP).

The challenge is not just in processing power but also in the memory and energy required to run complex algorithms on mobile devices. High-resolution images contain a massive amount of data, and processing this data in real-time on a device with limited resources is a challenging task. The key to overcoming this challenge lies in breaking down the problem into smaller, more manageable pieces.

In the related art, one approach to deploying AI based techniques on the user devices is patch-based image processing. This technique involves decomposing the input image into smaller, overlapping patches, restoring each patch separately using AI algorithms, and then merging the processed patches back together to form the final image. The computational load is distributed by dividing the image into smaller sections, making it feasible to run complex algorithms even on devices with limited resources.

However, while patch-based processing has been widely adopted for image restoration, it is not without its drawbacks. For example, the image may suffer from severe degradations that cause extreme colour changes in some regions. If individual patches of the image undergo different colour mapping during processing, the result can be visual artifacts-unwanted anomalies that disrupt the overall quality of the image. This problem may occur because the patch-based algorithm focuses exclusively on the local information within each patch, ignoring the global context of the entire image.

As a result, adjacent patches may not blend seamlessly, leading to abrupt colour transitions that are visually jarring. These artifacts may significantly detract from the final image quality, undermining the very enhancements that the AI based techniques were designed to achieve.

While advances in mobile camera sensors and AI-based image restoration have greatly improved the quality of images, challenges like moiré patterns, uneven illumination, and the limitations of patch-based processing remain.

Thus, there is a requirement to address these challenges, particularly in developing techniques that can integrate local and global information more effectively, ensuring that high-quality image restoration can be achieved.

### SUMMARY

### Technical Solution

Aspects will be set forth in part in the description which follows and, in part, will be apparent from the description, or may be learned by practice of the presented embodiments.

According to an aspect of the disclosure, provided is a method for restoration of a captured image, the method may include: blurring the captured image based on removing high spatial frequency content and maintaining colour characteristics of the captured image; generating a global colour attention map corresponding to the blurred captured image, where the global colour attention map indicates spatial representation of colour composition among regions within the blurred captured image; splitting the captured image into a plurality of patches; extracting one or more task features from the plurality of patches, where the one or more task features indicate characteristics related to a corresponding task; generating stitched features corresponding to the plurality of patches, respectively, based on correlating the one or more task features and the global colour attention map, where the stitched features indicate an integrated representation of the captured image based on a global context and the corresponding task; refining the plurality of patches based on the generated stitched features; and generating a restored image based on a concatenation of the refined plurality of patches.

The method may further include: displaying the restored image on a user device such that the restored image has enhanced colour consistency compared to the captured image prior to the blurring.

The method may further include, prior to the blurring the captured image: receiving the captured image from a camera associated with a user device; and resizing the captured image into a low-resolution image based on removing pixels from the captured image.

The generating the global colour attention map may include: extracting first task features from a first scale image indicating the captured image prior to the blurring; extracting second task features from a second scale image indicating the blurred captured image; obtaining spatial feature maps corresponding to the first task features and the second task features, based on applying a global average pooling, where the spatial feature map indicates spatial location of features in the first scale image and the second scale image; concatenating the spatial feature maps associated with the first scale image and the second scale image respectively; and generating the global colour attention map based on the concatenation.

The generating the stitched features may include: receiving a first global colour attention map associated with a first scale image indicating the captured image prior to the blurring, and a second global colour attention map associated with a second scale image indicating the blurred captured image; receiving one or more first task features from the plurality of patches associated with the first scale image, and one or more second task features associated with the second scale image; correlating the first global colour attention map associated with the first scale image with corresponding first task features associated with the first scale image; correlating the second global colour attention map associated with the second scale image with corresponding second task features associated with the second scale image; concatenating the first global colour attention map correlated with the corresponding first task features and the second global colour attention map correlated with the corresponding second task features; and generating the stitched features based on the concatenation such that the generated stitched features provide the integrated representation of the captured image based on the global context and the corresponding task.

The refining the plurality of patches may include: performing image operations on the generated stitched features using a series of convolutional layers, where the image operations include filtering, feature extraction, and feature enhancement among the plurality of patches; and refining the plurality of patches based on converting the generated stitched features into a colour model representing colours in a RGB domain.

According to an aspect of the disclosure, provided is a system for restoration of a captured image, the system may include: a memory storing instructions; at least one processor in communication with the memory, where, by executing the instructions, the at least one processor is configured to: blur the captured image based on removing high spatial frequency content and maintaining colour characteristics of the captured image; generate a global colour attention map corresponding to the blurred captured image, where the global colour attention map indicates spatial representation of colour composition among regions within the blurred captured image; split the captured image into a plurality of patches; extract one or more task features from the plurality of patches, where the one or more task features indicate characteristics related to a corresponding task; generate stitched features corresponding to the plurality of patches based on correlating the one or more task features and the global colour attention map, where the stitched features indicate an integrated representation of the captured image based on a global context and the corresponding task; refine the plurality of patches based on the generated stitched features; and generate a restored image based on a concatenation of the refined plurality of patches.

The at least one processor may be further configured to: display the restored image on a user device such that the restored image has enhanced colour consistency compared to the captured image prior to blurring.

The at least one processor may be further configured to, prior to the blurring the captured image: receive the captured image from a camera associated with a user device; and resize the captured image into a low-resolution image based on removing pixels from the captured image.

To generate the global colour attention map, the at least one processor may be configured to: extract first task features from a first scale image indicating the captured image prior to the blurring; extract second task features from a second scale image indicating the blurred captured image; obtain spatial feature maps corresponding to the first task features and the second task features, based on applying a global average pooling, where the spatial feature map indicates spatial location of features in the first scale image and the second scale image; concatenate the spatial feature maps associated with the first scale image and the second scale image respectively; and generate the global colour attention map based on the concatenation.

To generate the stitched features, the at least one processor may be configured to: receive a first global colour attention map associated with a first scale image indicating the captured image prior to the blurring and a second global colour attention map associated with a second scale image indicating the blurred captured image; receive one or more first task features from the plurality of patches associated with the first scale image, and one or more second task features from the plurality of patches associated with the second scale image; correlate the first global colour attention map associated with the first scale image with corresponding first task features associated with the first scale image; correlate the second global colour attention map associated with the second scale image with corresponding second task features associated with the second scale image; concatenate the first global colour attention map correlated with the corresponding first task features and the second global colour attention map correlated with the corresponding second task features; and generate the stitched features based on the concatenation such that the generated stitched features provide the integrated representation of the captured image based on the global context and the corresponding task.

To refine the plurality of patches, the at least one processor may be configured to: perform image operations on the generated stitched features using a series of convolutional layers, where the image operations include filtering, feature extraction, and feature enhancement among the plurality of patches; and refine the plurality of patches based on converting the generated stitched features into a colour model indicating the representation of colours in a RGB domain.

### BRIEF DESCRIPTION OF DRAWINGS

These and other features, aspects, and advantages of the present disclosure will become better understood when the following detailed description is read with reference to the accompanying drawings in which like characters represent like parts throughout the drawings, wherein:

FIG. 1 illustrates a schematic block diagram depicting an environment for the implementation of a system for restoration of a captured image, according to an embodiment;

FIG. 2 illustrates a schematic block diagram of modules components of the system for restoration of the captured image, according to an embodiment;

FIG. 3 illustrates a process flow associated with a preprocessing module of the system, according to an embodiment;

FIG. 4 illustrates a process flow associated with a Stitching Feature Extractor module of the system, according to an embodiment;

FIG. 5 illustrates a process flow associated with a splitting module and a Task Feature Extractor module of the system, according to an embodiment;

FIG. 6 illustrates a process flow associated with a domain stitching module of the system, according to an embodiment;

FIG. 7 illustrates a process flow associated with a generating module of the system, according to an embodiment;

FIG. 8 illustrates an exemplary use-case scenario for restoration of the captured image, according to an embodiment;

FIG. 9 illustrates a flowchart depicting a method for restoration of the captured image, according to an embodiment; and

FIG. 10 illustrates an exemplary use-case scenario for the restoration of the captured image, according to an embodiment.

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the disclosure. Furthermore, in terms of the construction of the device, one or more components of the device may have been represented in the drawings by conventional symbols, and the drawings may show only those specific details that are pertinent to understanding the embodiments of the disclosure so as not to obscure the drawings with details that will be readily apparent to those of ordinary skill in the art having the benefit of the description herein.

### DETAILED DESCRIPTION

Hereinafter, example embodiments of the disclosure will be described in detail with reference to the accompanying drawings. The same reference numerals are used for the same components in the drawings, and redundant descriptions thereof will be omitted. The embodiments described herein are example embodiments, and thus, the disclosure is not limited thereto and may be realized in various other forms. The terms including technical or scientific terms used in the disclosure may have the same meanings as generally understood by those skilled in the art.

It will be understood by those skilled in the art that the foregoing general description and the following detailed description are explanatory of the disclosure and are not intended to be restrictive thereof.

Reference throughout this specification to “an aspect,” “another aspect” or similar language means that a particular feature, structure, or characteristic described in connection with the embodiment is included in at least one embodiment of the present disclosure. Thus, appearances of the phrase “in an embodiment,” “in another embodiment” and similar language throughout this specification may, but do not necessarily, all refer to the same embodiment.

The terms “includes,” “including,” “has,” “having,” “comprises”, “comprising”, and the like specify the presence of stated features, figures, steps, operations, components, members, or combinations thereof, but do not preclude the presence or addition of one or more other features, figures, steps, operations, components, members, or combinations thereof. For example, a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

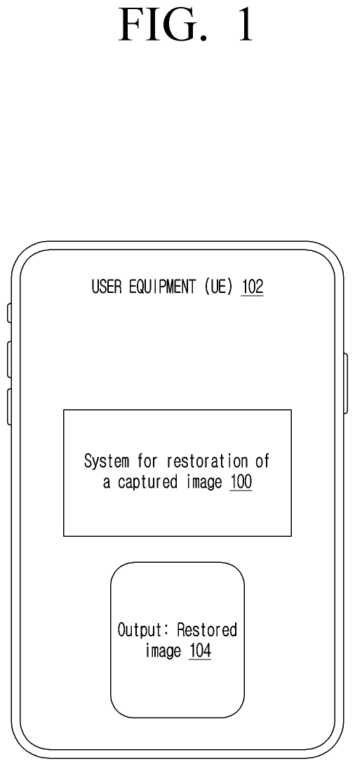

FIG. 1 illustrates a schematic block diagram depicting an environment for the implementation of a system for restoration of a captured image, according to an embodiment of the disclosure.

In an embodiment, referring to FIG. 1, the system 100 may be implemented in a user equipment (“UE”) 102 as an application installed in the UE 102 and running on an operating system (OS) of the UE 102 that generally defines a first active user environment. The OS typically presents or displays the application through a graphical user interface (“GUI”) of the OS. In a non-limiting example, the UE 102 may be a laptop computer, a desktop computer, a Personal Computer (PC), a notebook, a smartphone, a tablet, a smartwatch, or any device capable of displaying electronic media.

A user may interact with the UE 102; for instance, the user may capture images. The system 100 may be configured to provide an output by restoring a captured image. In an embodiment, the captured image may include any image that is pre-stored in a memory of the UE 102 and may include images directly captured via a camera module of the UE 102.

In an embodiment, the system 100 may perform efficient patch-based image processing on the UE 102, such as, for instance, restoration of screen-captured images, enhancement of low-light images, image composition, and in-painting of large areas. In an embodiment, the user may capture a screen that is degraded by moiré patterns (e.g., characterized by strips of varying colours, thicknesses, and orientations). The system 100 may process the image (screen capture) by dividing it into smaller overlapping patches. In some embodiments, the patches may correspond to smaller, manageable sections into which the screen-captured images are divided for processing. The patches are typically derived by splitting the image into a grid of overlapping or non-overlapping segments, depending on the specific requirements of the restoration or enhancement task. Thus, each patch may represent a localized region of the captured image, allowing for focused analysis and processing of smaller areas rather than handling the entire image at once. In an advantageous aspect, the division of the image into the patches may be beneficial for tasks such as feature extraction, noise reduction, or fine-detail enhancement, thereby ensuring that the unique characteristics of each region are preserved and addressed individually. Furthermore, each patch may be restored individually, effectively removing visual artefacts such as the moiré patterns while preserving the original image quality. Consequently, the restored image 104 may be generated by the system 100 by concatenating the restored patches. In an embodiment, for low-light images or those with uneven illumination, where different areas require exposure correction, the system 100 may similarly divide the image into patches. Each patch may be corrected based on its specific needs, by utilizing global colour information to ensure smooth transitions between patches, preventing colour inconsistencies and visual boundary artefacts.

In an embodiment, in the context of image composition, where maintaining consistent colour across different parts of the image is desirable, the system 100 may integrate global colour information with local patch processing. Consequently, the composed image appears cohesive and natural, with no jarring colour transitions. In an embodiment, for in-painting large areas in which an object has been removed in the image, the system 100 may use patch-based processing to accurately fill in the missing regions. Consequently, the system 100 may ensure that the in-painted areas blend seamlessly with the surrounding content, based on considering the overall geometric and colour structure of the image. Thus, in some embodiments, the system 100 may allow precise and high-quality image restoration and enhancement, even on a resource-constrained UE 102, by combining local patch processing with global contextual information to produce visually coherent results across a range of applications.

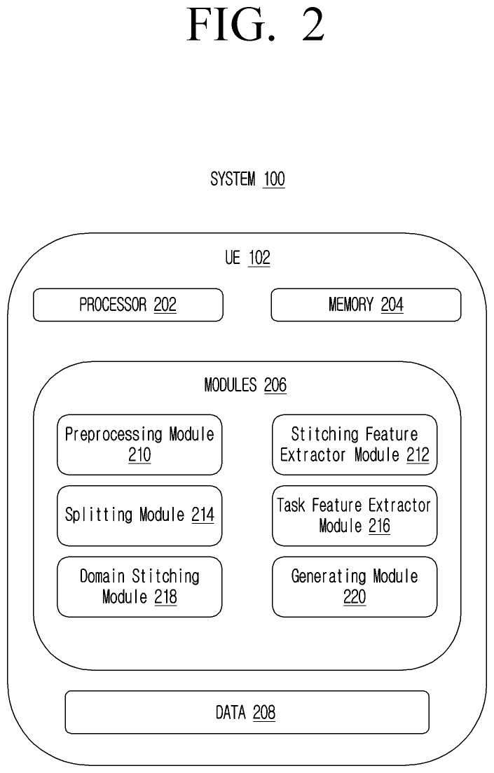

Further, the output (e.g., the restored image 104) may be determined and implemented using one or more modules of the system 100 as explained in forthcoming paragraphs of FIGS. 2-7.

FIG. 2 illustrates a schematic block diagram of modules components of the system 100 for restoration of the captured image in the UE 102, according to some embodiments.

The UE 102 may include, but is not limited to, a processor 202, memory 204, modules 206, and data 208. The modules 206 and the memory 204 may be coupled to the processor 202.

The processor 202 may include a single processing unit or several units, all of which could include multiple computing units. The processor 202 may be implemented as one or more microprocessors, microcomputers, microcontrollers, digital signal processors, central processing units, state machines, logic circuitries, and/or any devices that manipulate signals based on operational instructions. Among other capabilities, the processor 202 may be configured to fetch and execute computer-readable instructions and data stored in the memory 204.

The memory 204 may include one or more of any non-transitory computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and magnetic tapes. In some embodiments, the memory 204 may be referred to as the database 204 in the present disclosure, within the scope of the disclosure.

As is traditional in the field, the embodiments are described, and illustrated in the drawings, in terms of functional blocks, units and/or modules. Each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the embodiments may be physically separated into two or more interacting and discrete blocks, units and/or modules without departing from the present scope. Further, the blocks, units and/or modules of the embodiments may be physically combined into more complex blocks, units and/or modules without departing from the present scope.

For example, the modules 206, amongst other things, may include routines, programs, objects, components, data structures, etc., which perform particular tasks or implement data types. The modules 206 may also be implemented as, signal processor(s), state machine(s), logic circuitries, and/or any other device or component that manipulates signals based on operational instructions.

Further, the modules 206 may be implemented in hardware, instructions executed by a processing unit, or by a combination thereof. The processor 202 may include a computer, a processor, a state machine, a logic array, or any other suitable devices capable of processing instructions. The processing unit can be a general-purpose processor (e.g., processor 202) which executes instructions to cause the general-purpose processor to perform the required tasks or, the processing unit can be dedicated to performing the required functions. In an embodiment of the present disclosure, the modules 206 may be machine-readable instructions (software) which, when executed by the processor 202/processing unit, perform any of the described functionalities/methods, as discussed throughout the present disclosure.

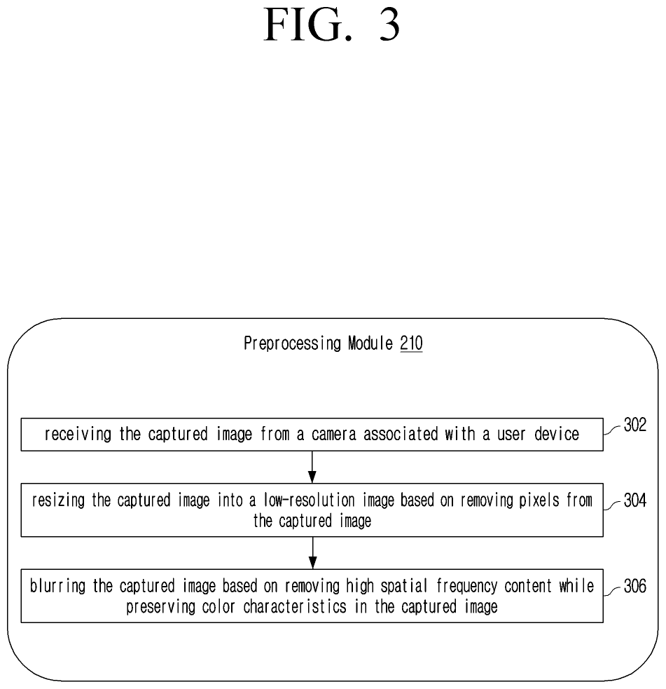

In some embodiments, the modules 206 may include a preprocessing module 210, a stitching feature extractor module 212, a splitting module 214, a task feature extractor module 216, a domain stitching module 218, and a generating module 220. The preprocessing module 210, the stitching feature extractor module 212, the splitting module 214, the task feature extractor module 216, the domain stitching module 218, and the generating module 220 may be in communication with each other. The data 208 may serve, amongst other things, as a repository for storing data processed, received, and generated by one or more of the modules 206. FIGS. 3-7 provide detailed descriptions of each of the modules 206.

FIG. 3 illustrates a process flow associated with the preprocessing module 210 of the system 100, according to some embodiments.

In an embodiment, at block 302, the preprocessing module 210 may be configured to receive a captured image directly from the UE 102. It may be understood that the “captured image” may be referred to as the image pre-stored in the memory 204 of the UE 102 or sourced from a camera module associated with the UE 102. The captured image may have visual artefacts such as moiré patterns. The initial input i.e., the captured image may undergo various transformations to prepare it for restoration and remove the visual artefacts.

At block 304, the preprocessing module 210 may be configured to resize the captured image into a low-resolution image by removing pixels. The reduction of the captured image into the low-resolution image may simplify the image, which may make it less detailed but easier to process, which may allow for processing on devices with limited computational power. In an embodiment, resizing may reduce the computational load required for further processing steps. Thus, by lowering the resolution, processing the captured image may become more manageable for subsequent operations, which may be advantageous when processing needs to be done quickly on mobile devices.

At block 306, the preprocessing module 210 may be configured to blur the captured image with the low-resolution by removing high spatial frequency content while preserving colour characteristics. The removal of high spatial frequency content, which typically corresponds to fine details and sharp edges in the captured image, may simplify the image by filtering out fine details. The high spatial frequency content with reference to the captured image refers to regions in the captured image with rapidly changing intensity values of pixels over short distances. The changes may be indicative of fine details and intricate structures within the captured image, such as edges, sharp transitions, and textures. Fine details indicate getting more contrasty images, with well-defined elements for example, in the image the pores of skin, the individual eyelashes, the reflections in water. Sharp edges refers to an edge as the boundary between different image parts. The edges of any object in an image are typically defined as the regions in an image where there is a sudden change in intensity. Further, the boundary between two contrasting objects or the detailed surface patterns of the object are typically associated with the high spatial frequency. Furthermore, in contrast, low spatial frequency content may correspond to regions with gradual or minimal changes in pixel intensity, representing smooth and uniform areas of the image, such as the sky or a plain surface. In an advantageous aspect, the high spatial frequency content may play a critical role in defining the sharpness and clarity of the captured image. Thus, the high spatial frequency content captures the intricate information that allows for precise object recognition and detail analysis. Furthermore, the removal of high spatial frequency content during blurring may advantageously simplify the captured image, making it useful for applications that require global context or color analysis while temporarily discarding detailed information.

In an embodiment, after resizing, the preprocessing module 210 may apply a blurring effect to the captured image. The blurring may smooth out the fine details and sharp edges while ensuring that the overall colour characteristics of the captured image are preserved. Further, the colour characteristics correspond to the fundamental attributes for defining the recognition of colour and differentiation in visual content. The colour characteristics may include hue, saturation, and brightness. In one example, hue determines the type of colour such as red, blue or green and is defined by the wavelength of light. In one example, saturation as a colour characteristic may refer to the intensity or purity of the colour. In one example, high saturation may represent vivid and rich colours, while low saturation results in muted or pastel-like tones. In one example, brightness also known as value or lightness, indicates the light or dark appearance of the color. In an advantageous aspect, the colour characteristics create the complete perception of colour, making colours essential for accurate representation in the image. Advantageously, maintaining colour characteristics during image restoration ensures visual coherence and enhances aesthetic appeal, ensuring that the restored image accurately represents its original hues, tones, and contrasts. Thus, blurring may be used to simplify the captured image further by focusing on the broader colour and tonal regions rather than fine details. In some embodiments, blurring may create a version of the captured image that emphasizes colour and spatial consistency, which may be used in subsequent operations of the restoration process.

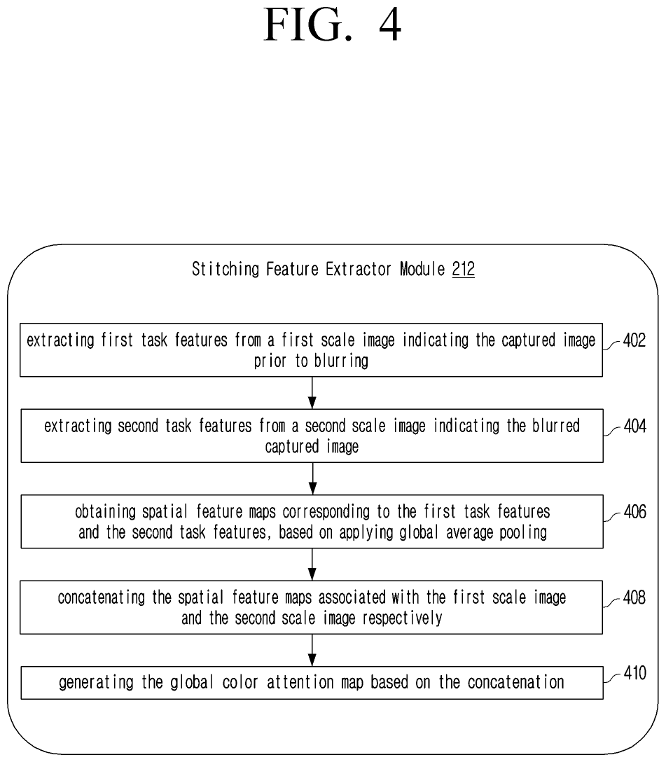

FIG. 4 illustrates a process flow associated with the stitching feature extractor module 212 of the system 100, according to some embodiments of the disclosure.

In an embodiment, the stitching feature extractor module 212 may be configured to consider both local and global image features in the captured image (pre-processed), and may particularly focus on colour consistency across the captured image. This stitching feature extractor module 212 may be configured to generate a global colour attention map, which may highlight the specific colour-related areas of the captured image.

At block 402, the stitching feature extractor module 212 may be configured to extract first-task features from a first scale image. In an embodiment, the first scale image may refer to the captured image before preprocessing (e.g., before the blurring).

Further, the first-task features may correspond to specific attributes or characteristics of the captured image that may be relevant to the restoration process. For example, edges, textures, or other detailed elements to be preserved or enhanced during restoration. Thus, extraction of the first task features may help in identifying and preserving specific details from the original image before any blurring is performed. Consequently, this may ensure that critical information is not lost in the subsequent restoration steps.

At block 404, the stitching feature extractor module 212 may be configured to extract second-task features from a second scale image. In an embodiment, the second scale image may refer to the blurred captured image.

Further, blurring may reduce high spatial frequency content, simplifying the captured image by focusing on broader colour and shape information rather than fine details. The stitching feature extractor module 212 may be configured to extract the second task features from the blurred image, which may be more generalized and related to the overall colour and spatial structure rather than fine details. In some embodiments, extracting the second task features from the blurred image may help in capturing the broader context and colour distribution within the captured image. In some instances, this step may ensure that the restoration process considers not only the details but also the overall image structure and colour composition.

At block 406, the stitching feature extractor module 212 may be configured to obtain respective spatial feature maps corresponding to the first task features and the second task features, based on applying global average pooling.

After extracting the task features from both the original and blurred images, the stitching feature extractor module 212 may be configured to create “spatial feature maps”. The spatial feature maps may indicate the spatial locations of the features within the captured image. Further, the stitching feature extractor module 212 may be configured to apply global average pooling to the spatial feature maps, which may include averaging the values of each feature across the entire captured image. In some instances, the global average pooling may reduce the complexity of the spatial feature maps while retaining essential spatial information about where specific features are located.

In some embodiments, the spatial feature maps may serve as a model, showing where certain features, both detailed and generalized, are located within the captured image. Thus, the spatial feature maps may provide an understanding of different areas of the captured image contributing to the overall appearance and their handling during the restoration process.

At block 408, the stitching feature extractor module 212 may be configured to concatenate the spatial feature maps associated with the first-scale image and the second-scale image respectively.

The spatial feature maps obtained from the original and blurred images may then be concatenated, or combined, into a single, unified representation. In an embodiment, the concatenation of the spatial feature maps associated with the first-scale image and the second-scale image may merge the detailed information from the original image with the generalized colour and spatial information from the blurred image.

The stitching feature extractor module 212 may be configured to create a comprehensive representation of the captured image that includes both detailed and global information, based on the concatenation. Thus, the concatenated spatial feature maps may provide a holistic view of the captured image, combining the best of both detailed features overall colour, and spatial structure.

At block 410, the stitching feature extractor module 212 may be configured to generate the global colour attention map based on the concatenation.

In some embodiments, the global colour attention map may highlight (e.g., identify) the regions of the captured image that are most important for maintaining colour consistency and overall visual quality. The global colour attention map may guide the subsequent image restoration process, ensuring that the important areas are given priority in terms of colour accuracy and detail preservation.

In some embodiments, the global colour attention map may be a representation for capturing the lightness and the colour characteristics of the image while maintaining overall colour consistency. Further, the spatial distribution of colours across the entire image may be analysed to generate the global colour attention map thus ensuring that the color characteristics of the input image are accurately preserved and transferred while generating the output during processes such as restoration or transformation.

In some embodiments, the global colour attention map may be generated based on computing colour statistics from all pixels, thus enabling a comprehensive understanding of the colour composition across the image. In an advantageous aspect, the global colour attention map may highlight regions with requirements for colour adjustments or enhancements, thus ensuring that the restored image remains true to original colour distribution while addressing global consistency.

In some embodiments, the global colour attention map may act as a blueprint for the restoration process, helping to ensure that colour consistency is maintained across the entire image. In some instances, the global colour attention map may ensure that both detailed features and the overall colour structure are preserved, leading to a more visually coherent and high-quality restored image. In an embodiment, the global colour attention map may include a first global colour attention map associated with a first scale image, and a second global colour attention map associated with a second scale image.

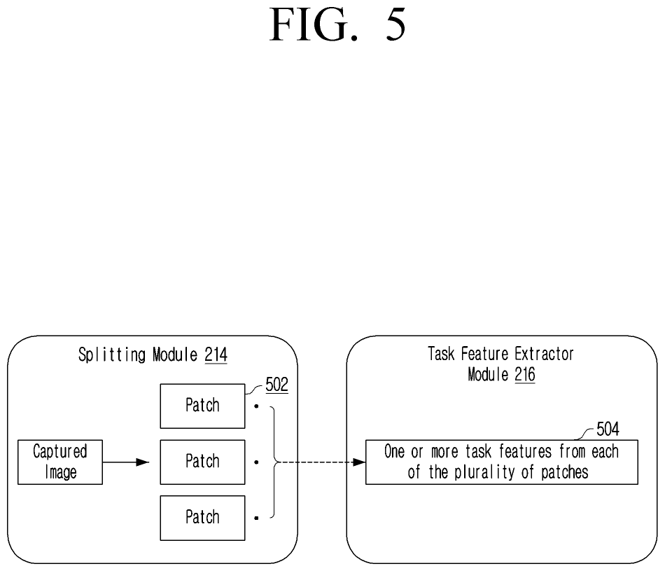

FIG. 5 illustrates a process flow associated with the splitting module 214 and the task feature extractor module 216 of the system 100, according to some embodiments.

In an embodiment, at block 502, the splitting module 214 may be configured to divide the captured image into smaller, manageable sections referred to as a plurality of patches. Thus, the captured image may be split into a grid of overlapping or non-overlapping patches, depending on the specific requirements of the restoration task. Each of the plurality of patches may represent a smaller, localized region of the captured image.

In an embodiment, the plurality of patches may overlap slightly to ensure that no detail is lost at the boundaries of each of the plurality of patches. This overlap may help maintain consistency between adjacent patches, reducing the likelihood of visual artefacts.

In an embodiment, the plurality of patches may be non-overlapping, in which each of the plurality of patches represents a distinct and separate section of the captured image. In some instances, this may make the restoration processing more efficient.

In an embodiment, splitting the captured image into the plurality of patches may allow the restoration process to focus on smaller sections of the captured image individually, thus may allow for implementation by devices with limited processing power. The system 100 thus, based on handling smaller pieces (the plurality of patches), may apply more precise and efficient algorithms that would be too computationally expensive if applied to the entire image at once. In some embodiments, splitting the image into the plurality of patches may make it easier to parallelize the processing of patches, further speeding up the restoration process.

In an embodiment, at block 504, the task feature extractor module 216 may be configured to extract task features from each of the plurality of patches.

The task feature extractor module 216 may be configured to receive the plurality of patches from the splitting module 214. The task features may correspond to specific attributes or characteristics within each of the plurality of patches that are relevant to the particular restoration task at hand.

The characteristics of the task features may depend on the specific restoration task being performed. For instance, if the task is to remove noise, the task features may include patterns or textures that need smoothing; if the task is colour correction, the task features may focus on colour balance and hue within each of the plurality of patches; etc.

The task feature extractor module 216 may be configured to process at a localized level (e.g., examine the specific details within each of the plurality of patches rather than the captured image as a whole). In some instances, this may allow for highly detailed and task-specific adjustments to be made to each section of the captured image.

Further, the extraction of the task features may allow for modifying the restoration process to the specific needs of each of the plurality of patches. Thus, the system 100 may apply precise adjustments that enhance the quality of the captured image in a way that is optimized for the specific task, such as deblurring, denoising, colour correction, or the like based on identifying the relevant characteristics within each of the plurality of patches.

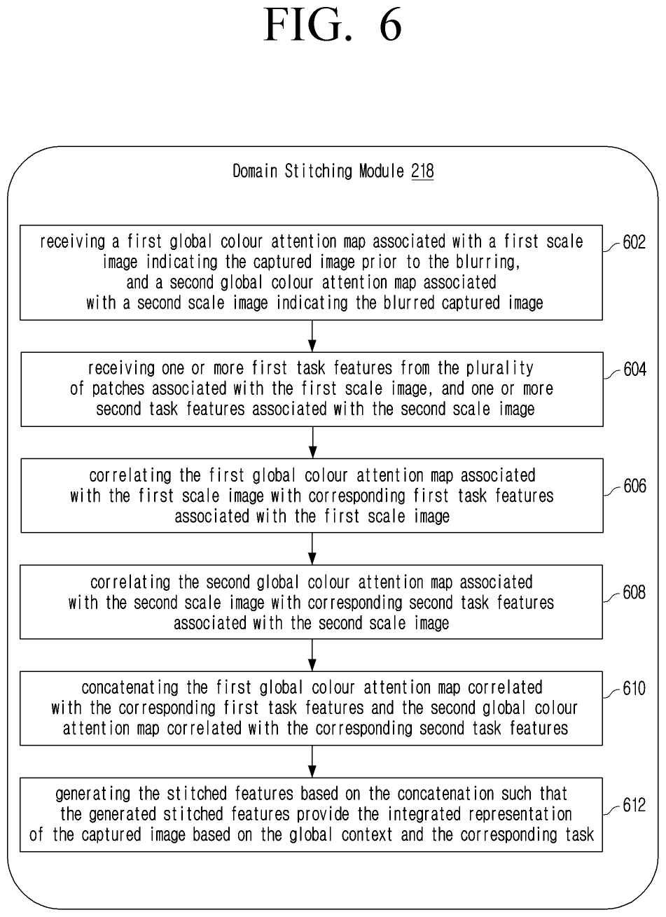

FIG. 6 illustrates a process flow associated with the domain stitching module 218 of the system 100, according to some embodiments of the disclosure.

In an embodiment, the domain stitching module 218 may be configured to integrate global and local information for the effective restoration of the captured image. In some instances, the domain stitching module 218 may ensure that the restored image maintains both overall colour consistency and detailed task-specific enhancements, which may result in a coherent and visually pleasing outcome based on combining global colour information and the task-specific features.

At block 602, the domain stitching module 218 may be configured to receive the first global colour attention map associated with the first-scale image and the second global colour attention map associated with the second-scale image.

The domain stitching module 218 may be configured to receive the global colour attention maps for both the first-scale image (i.e., the original, unblurred image) and the second-scale image (i.e., the blurred version of the captured image). In some instances, the global colour attention maps as stated in previous paragraphs, may highlight (e.g., identify) the important colour regions across the entire captured image. Thus, the global colour attention maps may provide crucial information about which areas of the captured image may be most significant for maintaining colour consistency. These global colour attention maps model the stitching process to ensure that the final image preserves the correct colour balance across different regions.

At block 604, the domain stitching module 218 may be configured to receive the one or more task features from each of the plurality of patches associated with the first-scale image and the second-scale image, respectively. For example, the domain stitching module 218 may receive first task features from the plurality of patches associated with the first scale image, and second task features from the plurality of patches associated with the second scale image. The one or more task features may correspond to localized information within each of the plurality of patches, such as details relevant to noise reduction, deblurring, or colour correction. For instance, the one or more task features may include edges, textures, or colour patterns within a patch that are relevant to restoring image clarity or ensuring colour consistency. In an advantageous aspect, the one or more task features may provide a focused representation of the patch's content, thereby enabling targeted adjustments for addressing localized imperfections or inconsistencies. Consequently, the one or more task features may achieve a balance between addressing global image coherence and preserving the fine-grained details unique to each of the plurality of patches during the restoration.

In some embodiments, the one or more task features may correspond to characteristics within each patch of the image that are relevant to achieving a particular image restoration or enhancement. The characteristics indicate specific visual attributes or patterns within each patch that are relevant to a particular restoration or enhancement, such as pixel intensity variations, edges, gradients, or color imbalances. For example, in noise reduction, the one or more task features may include patterns of pixel intensity variations that indicate the presence of noise artefacts. In the case of deblurring, the one or more task features may highlight edges or gradients within the patch that require enhancement to sharpen blurred areas. Similarly, for colour correction, the one or more task features may focus on identifying discrepancies in the colour balance that may require adjustment. Consequently, the one or more task features may guide the restoration process based on the localized information necessary for improving the image with the specific objective, for example, but not limited to, reducing noise, sharpening details, or correcting colour imbalances.

The one or more task features may enable precise, localized adjustments to the captured image. Thus, the domain stitching module 218 may be configured to ensure that the restoration process addresses specific issues within each of the plurality of patches while still considering the global colour context, based on incorporating the one or more task features.

At block 606, the domain stitching module 218 may be configured to correlate the first global colour attention map associated with the first-scale image with the corresponding one or more first task features associated with the first-scale image.

In an embodiment, the correlation may identify alignment of the global colour information map with the local features extracted from the plurality of patches. Thus, correlating the global colour attention maps with the one or more task features may integrate broad colour trends with detailed local information, ensuring that the restoration process is both globally coherent and locally precise.

At block 608, the domain stitching module 218 may be configured to correlate the second global colour attention map associated with the second scale image (i.e., the blurred captured image) with the corresponding one or more second task features associated with the second scale image.

In some instances, the domain stitching module 218 may help maintain the colour and spatial consistency of the captured image, even when dealing with generalized or blurred content.

In some instances, the domain stitching module 218 may ensure that the broader, less detailed colour information from the blurred captured image is harmonized with the task-specific details, providing a balanced approach to restoration based on correlating the one or more task features.

At block 610, the domain stitching module 218 may be configured to concatenate the global colour attention map and the corresponding one or more task features based on correlation.

In an embodiment, post the correlating blocks 606 and 608, the domain stitching module 218 may be configured to concatenate the global colour attention maps with the task features for both the first and second scale images. In an embodiment, concatenation may refer to combining the global and local information into a unified representation that captures both the overall colour context and the specific details within each of the plurality of patches.

In some embodiments, the concatenation may create a comprehensive set of features that can be used to model the final image restoration. This unified feature set may ensure that the final image is consistent in terms of colour and spatial structure while addressing localized issues effectively.

At block 612, the domain stitching module 218 may be configured to generate the stitched features based on concatenation such that the generated stitched features provide an integrated representation of global and task-specific information.

In some embodiments, the stitched features may correspond to a comprehensive representation derived from the concatenation of the global colour context (e.g. global context) and detailed task-specific information extracted from the plurality of patches in the image. The stitched features may integrate the broader context of the image, captured through global colour context, with the task-specific information i.e., localized characteristics specific to each of the plurality of patches and their corresponding tasks. For instance, the global context referred to as the global colour context may include colour consistency and spatial coherence. Further, the global context may be computed based on taking into account all the pixels of the image. The global context may signify the overall content of the image. For instance, the task-specific information may address localized objectives such as noise reduction or edge enhancement. Thus, based on combining the global colour context and the task-specific information, the stitched features may create a unified representation retaining the global structure of the image while addressing fine-grained details. In an advantageous aspect, the stitched features enable precise restoration or enhancement by balancing global aesthetics with localized corrections.

Thus, the stitched features may be generated from the concatenated global and task-specific information or features. The stitched features provide a unified representation of the captured image by combining two key elements i.e., the global color context, which ensures consistency and harmony across the image's overall color distribution, and the detailed task-specific information, which focuses on localized enhancements such as noise reduction, edge sharpening, or colour correction.

In some embodiments, the stitched features may serve as the foundation for the final restored image. The stitched features may ensure that the restoration process considers both the overall appearance of the captured image, and the specific corrections required in different regions, resulting in a visually coherent and high-quality final product.

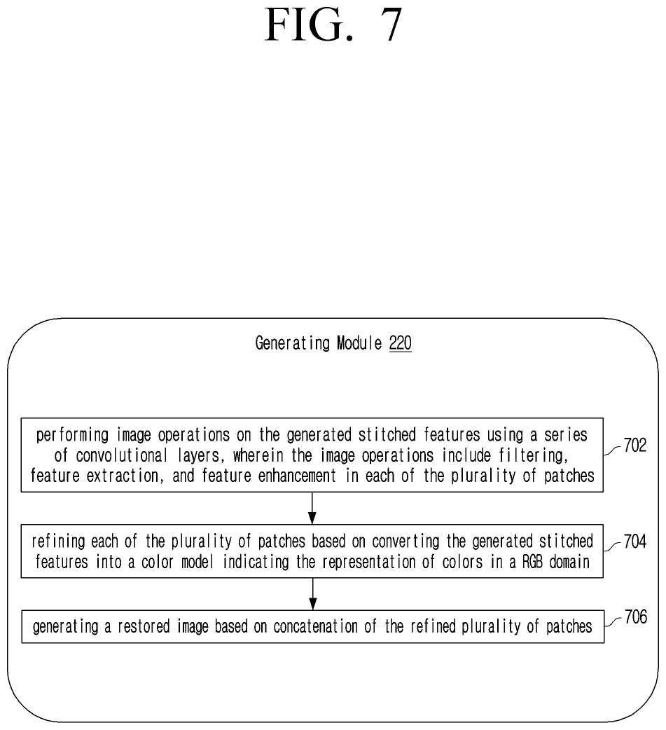

FIG. 7 illustrates a process flow associated with the generating module 220 of the system 100, according to some embodiments.

In an embodiment, the generating module 220 may be configured to further enhance and refine the previously processed and integrated features to produce the output (e.g., the restored image 104). In an embodiment, the generating module 220 module may include convolutional layers and colour model conversion, to ensure that the restored image 104 is both visually accurate and consistent.

At block 702, the generating module 220 may be configured to perform image operations on the generated stitched features using a series of convolutional layers. In an embodiment, the image operations may correspond to filtering, feature extraction, and feature enhancement in each of the plurality of patches.

In an embodiment, the series of convolutional layers may correspond to a fundamental component of deep learning models. The series of convolutional layers may be configured to perform various image operations, such as filtering, feature extraction, and feature enhancement, on the input data.

For instance, the series of convolutional layers may apply filters to the image features to highlight specific aspects, such as edges, textures, or patterns. In some instances, the series of convolutional layers may emphasize important details in each patch.

For instance, the series of convolutional layers may extract important features from the image, such as shapes, colours, and textures, that are a target of the restoration process.

For instance, the series of convolutional layers may enhance the extracted features, making them more prominent and correcting any distortions or degradations that may have occurred in the captured image.

In some embodiments, the step of performing image operations using the series of convolutional layers may allow for refining the details of the plurality of patches. Thus, the generating module 220 may ensure that the output (e.g., the restored image 104) is sharp, detailed, and free from common artifacts or distortions, based on the stitched features through the series of convolutional layers.

At block 704, the generating module 220 may be configured to refine each of the plurality of patches based on converting the generated stitched features into a colour model indicating the representation of colours in a red, green, and blue (RGB) domain. The RGB domain may correspond to digital imaging representing colour information.

In an embodiment, the generating module 220 may be configured to translate the processed image data (from image operations) into a format in which the colours are accurately represented within the RGB domain or spectrum. In some instances, the conversion may ensure that the colours in the output (e.g., the restored image 104) appear natural and consistent.

In an embodiment, the generating module 220 may be configured to refine each of the plurality of patches to correct any remaining colour inconsistencies, which may ensure that the colours are accurately represented and smoothly transitioned between adjacent patches.

In some instances, converting the stitched features into the RGB domain may ensure that the output (e.g., the restored image 104) maintains accurate and consistent colours across each of the plurality of patches. In some embodiments, the visual coherence of the restored image 104 may be enhanced, for example, in cases in which colour accuracy is desired, such as in photographs or detailed images.

At block 706, the generating module 220 may be configured to generate the restored image 104 based on the concatenation of the refined plurality of patches.

In an embodiment, the concatenation refers to stitching of the each of the plurality of patches back together, which may ensure seamless transitions between them.

In an embodiment, the plurality of patches refined in the previous block, may now be enhanced and colour corrected. Consequently, the generating module 220 may be configured to piece together (e.g. concatenation) the refined plurality of patches to form the full image (e.g., the restored image 104). In some instances, the generating module 220 may ensure that the boundaries between the plurality of patches upon concatenation are smooth, without visible seams or artefacts. The concatenation of the refined plurality of patches may be the final assembly of the image, in which all the processed patches are combined to produce a cohesive and visually accurate restored image 104. Therefore, the concatenation may ensure that the final output is not only detailed and high-quality, but also free from visual inconsistencies. Thus, the concatenation includes combining the refined plurality of patches into the restored image, thereby ensuring seamless transitions between them without visible seams or artefacts. Advantageously, the restored image thus is a cohesive, high-quality restored image, maintaining both detail and visual consistency.

The output result may be the restored image 104 which has been processed to remove artefacts, enhance features, and ensure colour consistency across the entire image.

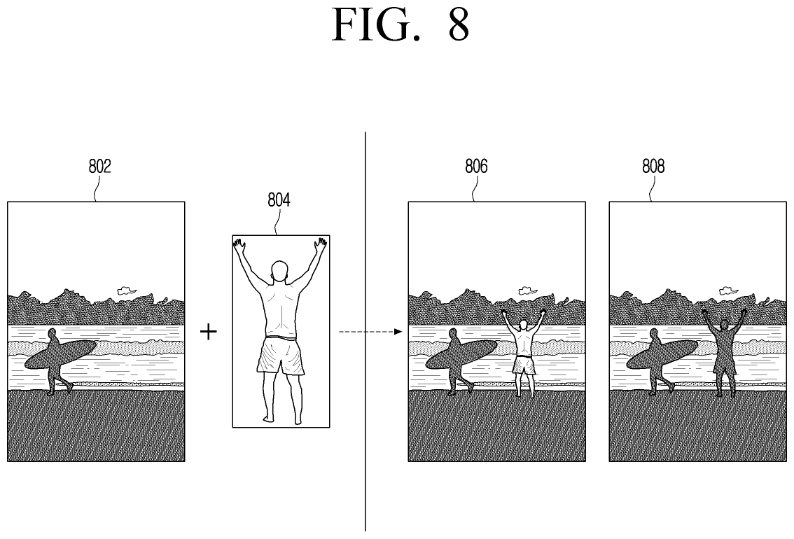

FIG. 8 illustrates an exemplary use-case scenario for the restoration of the captured image, according to some embodiments of the disclosure.

As illustrated, block 802 depicts a first image, while block 804 shows a second image. The user may aim to merge or superimpose the second image onto the first image. Without the present system 100, as shown in block 806, this superimposition may result in alpha blending, which can cause visible colour discrepancies between the first and second images, leading to an unsatisfactory visual effect. In contrast, at block 808, the system 100 may perform seamless blending of the second image to match the colour of the first image, significantly enhancing the overall aesthetics of the final output (e.g., the blended or restored image), as illustrated in block 806.

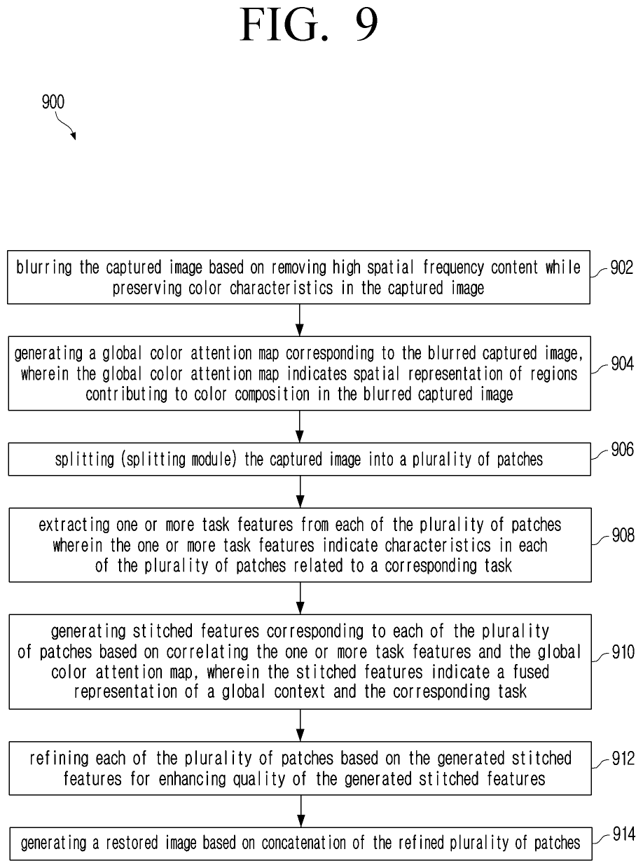

FIG. 9 illustrates an exemplary process flow including a method 900 for restoration of a captured image, according to some embodiments of the disclosure. The method 900 may be a computer-implemented method executed, for example, by the UE 102 and the modules 206. For the sake of brevity, constructional and operational features of the system 100 that are already explained in the description of FIGS. 1-8 are not explained in detail in the description of FIG. 9.

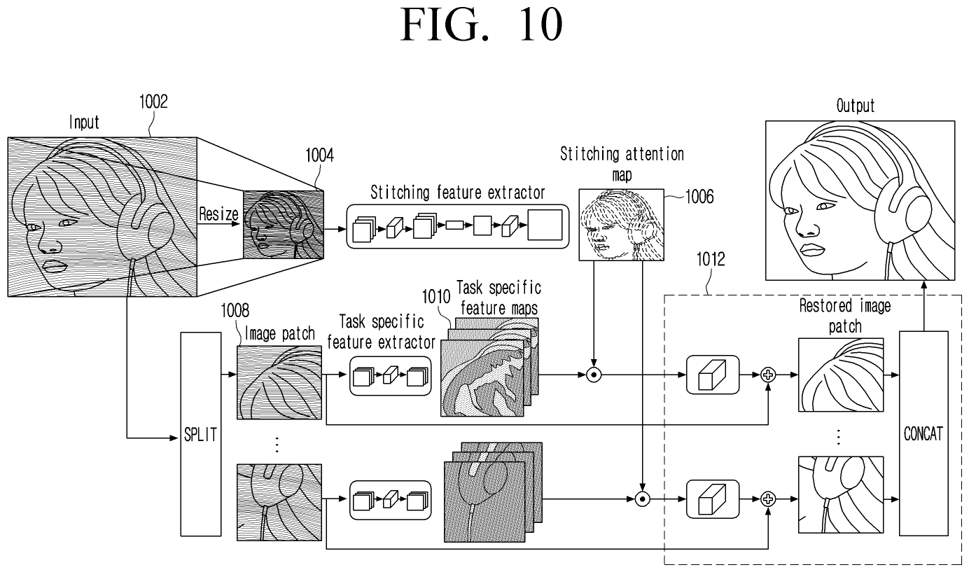

While the following discussed steps in FIG. 9 are shown and described in a particular sequence, the steps may occur in variations to the sequence in accordance with various embodiments. Further, a detailed description related to the various steps of FIG. 10 is already covered in the description related to FIGS. 1-8 and is omitted herein for the sake of brevity.

At step 902, the method 900 may include blurring the captured image based on removing high spatial frequency content while preserving colour characteristics in the captured image.

At step 904, the method 900 may include generating the global colour attention map corresponding to the blurred captured image. The global colour attention map may indicate the spatial representation of regions contributing to colour composition in the blurred captured image.

At step 906, the method 900 may include splitting the captured image into a plurality of patches.

At step 908, the method 900 may include extracting one or more task features from each of the plurality of patches. The one or more task features may indicate characteristics in each of the plurality of patches related to the corresponding task.

At step 910, the method 900 may include generating stitched features corresponding to each of the plurality of patches based on correlating the one or more task features and the global colour attention map. The stitched features may indicate a fused representation of a global context and the corresponding task.

At step 912, the method 900 may include refining each of the plurality of patches based on the generated stitched features for enhancing the quality of the generated stitched features.

At step 914, the method 900 may include generating the restored image based on the concatenation of the refined plurality of patches.

FIG. 10 illustrates an exemplary use-case scenario for the restoration of the captured image, according to an embodiment.

At step 1002, the input image is received. Further, at step 1004, the input image is resized to a lower resolution. In step 1006, the stitching feature extractor module 212 generates the global colour attention map alternatively referred to as the stitching attention map. The global colour attention map may highlight the regions of the input image crucial for maintaining colour consistency and overall visual quality. Thus, the global colour attention map may serve as a guide throughout the restoration, thereby ensuring that the most important areas of the input image are prioritized for accurate colour and detail preservation. Further, the stitching attention map aggregates the global colour information by leveraging the inter-spatial relationships of features, achieved through convolution operations.

At step 1008, the input image is divided into the plurality of patches using the splitting module 214. The plurality of patches may represent localized segments of the input image. In step 1010, the task feature extractor module 216 processes each of the plurality of patches, consequently extracting task-specific features that are relevant to the specific restoration objective. The task-specific features alternatively referred to as the task-specific feature maps may include characteristics like texture patterns for noise reduction, or colour balance for colour correction. The task feature extractor module 216 may enable precise adjustments to be made to each of the plurality of patches based on its unique characteristics.

At step 1012, the domain stitching module 218 correlates the global colour attention map (e.g., the stitching attention map) with the corresponding task features for each scale of the image. The domain stitching module 218 concatenates the global colour attention map with the localized task features for both the first and second-scale images. Consequently, the concatenation merges global and task-specific information into the unified representation, resulting in the generation of stitched features that integrate both the overall colour context and the detailed task-specific adjustments. Consequently, ensuring that the restored image maintains both colour accuracy and the necessary enhancements for each specific task.

Accordingly, some embodiments of the present disclosure may provide various advantages:

For example, some embodiments may enhance the overall quality of images by effectively addressing issues such as blurring, noise, and colour inconsistencies. The use of convolutional layers may ensure that fine details are preserved and enhanced, resulting in sharper and more visually appealing images.

Some embodiments may provide colour consistency and accuracy by converting the processed features into the RGB colour model and refining the patches. Accordingly, some embodiments may ensure that colours are consistent and accurate across the entire image. This may be particularly important in scenarios where color fidelity is desired, such as in professional photography or detailed imagery.

Some embodiments may address the challenge of visual artifacts and seams between adjacent patches. The concatenation process may ensure that the final image is smooth and cohesive, without visible boundaries or inconsistencies between different regions of the image.

Some embodiments may be versatile and can be adapted to address multiple types of image degradations, including moiré patterns, uneven illumination, and low-light noise. This may provide a single solution for a wide range of image restoration tasks.

Some embodiments provide a patch-based approach, combined with the integration of global and local features, which may allow for efficient processing even on resource-constrained devices such as mobile phones. This may make it feasible to perform high-quality image restoration without requiring extensive computational resources.

Some embodiments may provide enhanced global and local feature integration by correlating global colour attention maps with task-specific features. For example, one or more embodiments may provide an integrated representation that balances global context with localized detail. This may ensure that the restored image is not only visually consistent but also contextually accurate, maintaining the overall structure and content of the original scene.

Some embodiments may reduce the occurrence of visual artefacts, such as colour mismatches or unnatural transitions, which can occur when processing image patches independently. This may lead to a more natural and aesthetically pleasing final image.

Some embodiments described herein may apply to various use cases, including the restoration of images affected by moiré patterns, enhancement of low-light images, and correction of uneven illumination. This broad applicability makes it a valuable tool for different types of image restoration needs.

The convolutional layers used in some embodiments may be effective at preserving and enhancing fine details in the image, such as textures, edges, and small features, resulting in a high level of detail in the restored image.

Some embodiments may be configured to manage high-resolution images (e.g., greater than 8 MP), making it suitable for modern imaging devices that capture large, detailed images. The patch-based approach may ensure that even high-resolution images can be processed effectively without requiring a large processing load required by the device.

The above-described embodiments are merely specific examples to describe technical content according to the embodiments of the disclosure and help the understanding of the embodiments of the disclosure, not intended to limit the scope of the embodiments of the disclosure. Accordingly, the scope of various embodiments of the disclosure should be interpreted as encompassing all modifications or variations derived based on the technical spirit of various embodiments of the disclosure in addition to the embodiments disclosed herein.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

What is claimed is:

1. A method for restoration of a captured image, the method comprising:
blurring the captured image based on removing high spatial frequency content and maintaining colour characteristics of the captured image;
generating a global colour attention map corresponding to the blurred captured image, wherein the global colour attention map indicates spatial representation of a colour composition among regions of the blurred captured image;
splitting the captured image into a plurality of patches;
extracting one or more task features from the plurality of patches, wherein the one or more task features indicate characteristics related to a corresponding task;
generating stitched features corresponding to the plurality of patches, respectively, based on correlating the one or more task features and the global colour attention map, wherein the stitched features indicate an integrated representation of the captured image based on a global context and the corresponding task;
refining the plurality of patches based on the generated stitched features; and
generating a restored image based on a concatenation of the refined plurality of patches.

2. The method as claimed in claim 1, further comprising:
displaying the restored image on a user device such that the restored image has enhanced colour consistency compared to the captured image prior to the blurring.

3. The method as claimed in claim 1, wherein the method further comprises, prior to the blurring the captured image:
receiving the captured image from a camera associated with a user device; and
resizing the captured image into a low-resolution image based on removing pixels from the captured image.

4. The method as claimed in claim 1, wherein the generating the global colour attention map comprises:
extracting first task features from a first scale image indicating the captured image prior to the blurring;
extracting second task features from a second scale image indicating the blurred captured image;
obtaining spatial feature maps corresponding to the first task features and the second task features, based on applying a global average pooling, wherein the spatial feature map indicates spatial location of features in the first scale image and the second scale image;
concatenating the spatial feature maps associated with the first scale image and the second scale image respectively; and
generating the global colour attention map based on the concatenation.

5. The method as claimed in claim 1, wherein the generating the stitched features comprises:
receiving a first global colour attention map associated with a first scale image indicating the captured image prior to the blurring, and a second global colour attention map associated with a second scale image indicating the blurred captured image;
receiving one or more first task features from the plurality of patches associated with the first scale image, and one or more second task features associated with the second scale image;
correlating the first global colour attention map associated with the first scale image with corresponding first task features associated with the first scale image;
correlating the second global colour attention map associated with the second scale image with corresponding second task features associated with the second scale image;
concatenating the first global colour attention map correlated with the corresponding first task features and the second global colour attention map correlated with the corresponding second task features; and
generating the stitched features based on the concatenation such that the generated stitched features provide the integrated representation of the captured image based on the global context and the corresponding task.

6. The method as claimed in claim 1, wherein the refining the plurality of patches comprises:
performing image operations on the generated stitched features using a series of convolutional layers, wherein the image operations include filtering, feature extraction, and feature enhancement among the plurality of patches; and
refining the plurality of patches based on converting the generated stitched features into a colour model representing colours in a RGB domain.

7. A system for restoration of a captured image, the system comprising:
a memory storing instructions;
at least one processor in communication with the memory, wherein, by executing the instructions, the at least one processor is configured to:
blur the captured image based on removing high spatial frequency content and maintaining colour characteristics of the captured image;
generate a global colour attention map corresponding to the blurred captured image, wherein the global colour attention map indicates spatial representation of a colour composition among regions of the blurred captured image;
split the captured image into a plurality of patches;
extract one or more task features from the plurality of patches, wherein the one or more task features indicate characteristics related to a corresponding task;
generate stitched features corresponding to the plurality of patches based on correlating the one or more task features and the global colour attention map, wherein the stitched features indicate an integrated representation of the captured image based on a global context and the corresponding task;
refine the plurality of patches based on the generated stitched features; and
generate a restored image based on a concatenation of the refined plurality of patches.

8. The system as claimed in claim 7, wherein the at least one processor is further configured to:
display the restored image on a user device such that the restored image has enhanced colour consistency compared to the captured image prior to blurring.

9. The system as claimed in claim 7, wherein the at least one processor is further configured to, prior to the blurring the captured image:
receive the captured image from a camera associated with a user device; and
resize the captured image into a low-resolution image based on removing pixels from the captured image.

10. The system as claimed in claim 7, wherein to generate the global colour attention map, the at least one processor is configured to:
extract first task features from a first scale image indicating the captured image prior to the blurring;
extract second task features from a second scale image indicating the blurred captured image;
obtain spatial feature maps corresponding to the first task features and the second task features, based on applying a global average pooling, wherein the spatial feature map indicates spatial location of features in the first scale image and the second scale image;
concatenate the spatial feature maps associated with the first scale image and the second scale image respectively; and
generate the global colour attention map based on the concatenation.

11. The system as claimed in claim 7, wherein to generate the stitched features, the at least one processor is configured to:
receive a first global colour attention map associated with a first scale image indicating the captured image prior to the blurring and a second global colour attention map associated with a second scale image indicating the blurred captured image;
receive one or more first task features from the plurality of patches associated with the first scale image, and one or more second task features from the plurality of patches associated with the second scale image;
correlate the first global colour attention map associated with the first scale image with corresponding first task features associated with the first scale image;
correlate the second global colour attention map associated with the second scale image with corresponding second task features associated with the second scale image;
concatenate the first global colour attention map correlated with the corresponding first task features and the second global colour attention map correlated with the corresponding second task features; and
generate the stitched features based on the concatenation such that the generated stitched features provide the integrated representation of the captured image based on the global context and the corresponding task.

12. The system as claimed in claim 7, wherein to refine the plurality of patches, the at least one processor is configured to:
perform image operations on the generated stitched features using a series of convolutional layers, wherein the image operations include filtering, feature extraction, and feature enhancement among the plurality of patches; and
refine the plurality of patches based on converting the generated stitched features into a colour model indicating the representation of colours in a RGB domain.

13. A method for restoration of a captured image, the method comprising:
receiving the captured image from a camera associated with a user device;
resizing the captured image into a low-resolution image based on removing pixels from the captured image;
blurring the resized capture image and maintaining colour characteristics of the resized captured image;
generating a global colour attention map corresponding to the blurred captured image indicating spatial representation of colour compositions among regions within the blurred captured image;
splitting the captured image into a plurality of patches;
extracting one or more task features from the plurality of patches, wherein the one or more task features indicate characteristics related to a corresponding task;
generating stitched features corresponding to the plurality of patches, respectively, based on correlating the one or more task features and the global colour attention map;
refining the plurality of patches based on the generated stitched features; and
generating a restored image based on a concatenation of the refined plurality of patches.

14. The method of claim 13, wherein the generating the stitched features comprises:
receiving the global colour attention map corresponding to the blurred captured image;
receiving the one or more task features from the plurality of patches;
correlating the global colour attention map with the one or more task features;
concatenating the global colour attention map and the one or more task features; and
generating the stitched features based on the concatenation such that the generated stitched features provide an integrated representation of the captured image.

15. The method as claimed in claim 14, wherein the generating the global colour attention map comprises:
extracting the one or more task features from a second scale image indicating the blurred captured image;
obtaining a spatial feature map corresponding to the second task features, based on applying a global average pooling, wherein the spatial feature map indicates spatial location of features in the second scale image;
concatenating the spatial feature maps associated with the second scale image; and
generating the global colour attention map based on the concatenation.
